(19) United States
(12) Patent Application Publication
(10) Pub. No.: US 2018/0132023 A1
(43) Pub. Date: May 10, 2018

(54) MICROPHONE AND MANUFACTURING METHOD THEREOF

(71) Applicants: HYUNDAI MOTOR COMPANY, SEOUL (KR); KIA MOTORS CORPORATION, SEOUL (KR)

(72) Inventor: ILSEON YOO, Suwon-si (KR)

(73) Assignees: HYUNDAI MOTOR COMPANY, SEOUL (KR); KIA MOTORS CORPORATION, SEOUL (KR)

(21) Appl. No.: 15/627,997

(22) Filed: Jun. 20, 2017

(30) Foreign Application Priority Data
Nov. 8, 2016 (KR) 10-2016-0148370

(51) Int. Cl. H04R 1/04; H04R 9/08

(52) U.S. Cl. CPC H04R 1/04; H04R 21/02; H04R 2201/003; H04R 9/08

(57) ABSTRACT

The present disclosure provides a microphone including: a substrate having an acoustic hole; a vibration membrane formed on the substrate; an electromagnetic inducing layer with a predetermined pattern formed on a lower surface of the vibration membrane corresponding to the acoustic hole; a first electrode formed on an upper surface of the vibration membrane; a first fixing layer and a second fixing layer spaced apart from the vibration membrane; a second electrode having a plurality of through-holes formed at a lower surface of the first fixing layer; a first coil interposed between the first fixing layer and the second fixing layer, wherein the first coil is formed as a spiral shape extending outwardly from a center thereof; and a second coil bonded to an upper surface of the second fixing layer, wherein the second coil is formed as a spiral shape extending outwardly from a center thereof.

### CROSS-REFERENCE TO RELATED APPLICATION

The present application claims priority to and the benefit of Korean Patent Application No. 10-2016-0148370, filed on Nov. 8, 2016, which is incorporated herein by reference in its entirety.

### FIELD

The present disclosure relates to a microphone and a manufacturing method thereof.

### BACKGROUND

The statements in this section merely provide background information related to the present disclosure and may not constitute prior art.

Recently, a microphone, which converts a voice into an electrical signal, has been downsized, and downsized microphones are being developed based on a microelectromechanical system (MEMS) technology.

Such an MEMS microphone has a stronger humidity resistance and heat resistance than a conventional electret condenser microphone (ECM), and may be downsized and integrated with a signal processing circuit.

The MEMS microphone may be classified into a piezoelectric MEMS microphone and a capacitive MEMS microphone.

The piezoelectric MEMS microphone includes only a vibration membrane, and when the vibration membrane is deformed by an external sound pressure, an electrical signal is generated due to a piezoelectric effect. As a result, a sound pressure is measured based on the electrical signal.

The capacitive MEMS microphone includes a fixing membrane and a vibration membrane, and when external sound pressure is applied to the vibration membrane, a capacitance value thereof is changed because an interval between the fixing membrane and the vibration membrane is changed.

The capacitive MEMS microphone measures the sound pressure through an electrical signal generated at this time.

### SUMMARY

The present disclosure provides a microphone including: a substrate having an acoustic hole; a vibration membrane formed on the substrate; an electromagnetic inducing layer formed on a lower surface of the vibration membrane corresponding to the acoustic hole, wherein the electromagnetic inducing layer has a predetermined pattern; a first electrode formed on an upper surface of the vibration membrane; a first fixing layer and a second fixing layer disposed apart from the vibration membrane; a second electrode formed at a lower surface of the first fixing layer and to be provided with a plurality of through-holes; a first coil interposed between the first fixing layer and the second fixing layer and to be formed to have a spiral shape extending outwardly from a center thereof; and a second coil bonded to an upper surface of the second fixing layer and to be formed to have a spiral shape extending outwardly from a center thereof.

The predetermined pattern of the electromagnetic inducing layer may include a circular pattern in which a plurality of circular bands having different diameters are disposed, and a straight line pattern connecting the circular pattern and passing through a center of the circular pattern.

A first electrode hole may be formed at one side of the first and second fixing layers so that a first electrode pad formed at a front end of the first electrode is exposed, and a second electrode hole may be formed at the other side thereof so that a second electrode pad formed at a front end of the second electrode is exposed.

The first electrode hole may include a second support layer formed along an upper edge of the vibration membrane together with the first and second fixing layers.

A plurality of air passages may be formed at the first and second fixing layers corresponding to the plurality of through-holes formed in the second electrode.

The second fixing layer may include a coil groove so that a first coil pad formed at one end of the first coil is exposed.

Centers of the first coil and the second coil may be connected to each other.

The vibration membrane may be bonded to the substrate by a first support layer, wherein the first support layer is formed along an upper edge of the substrate.

In some forms of the present disclosure, it is possible to improve sensitivity by combining an electrical signal as a result of the capacitance change generated at a capacitance portion including a first electrode and a second electrode with an electrical signal as a result of an induced current generated at an electromagnetic inducing portion including an electromagnetic inducing layer, a first coil, and a second coil.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a cross-sectional view of a microphone;

FIG. 2 illustrates a top plan view of a microphone;

FIG. 3 illustrates a rear view of a microphone; and

FIG. 4 to FIG. 16 illustrate sequential processing diagrams of a manufacturing method for manufacturing a microphone.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

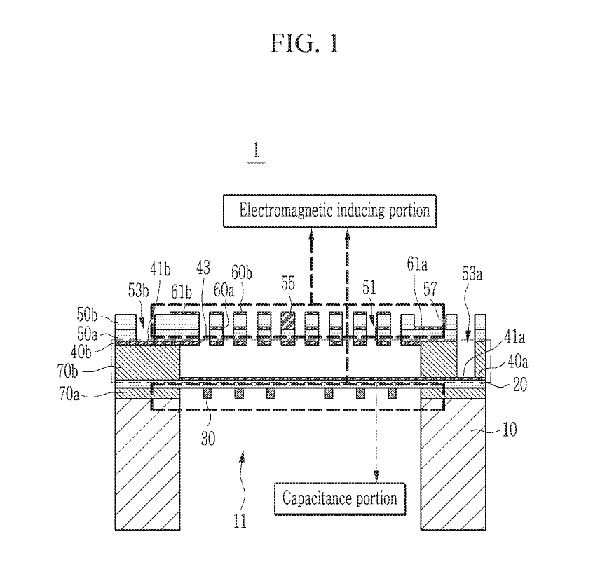

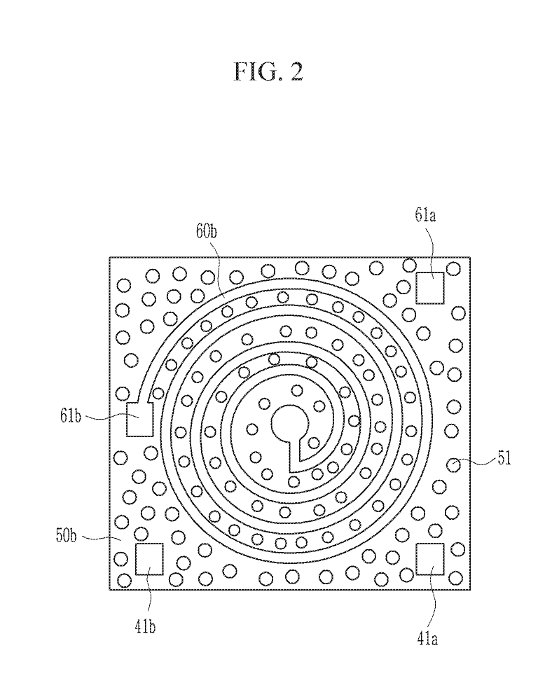

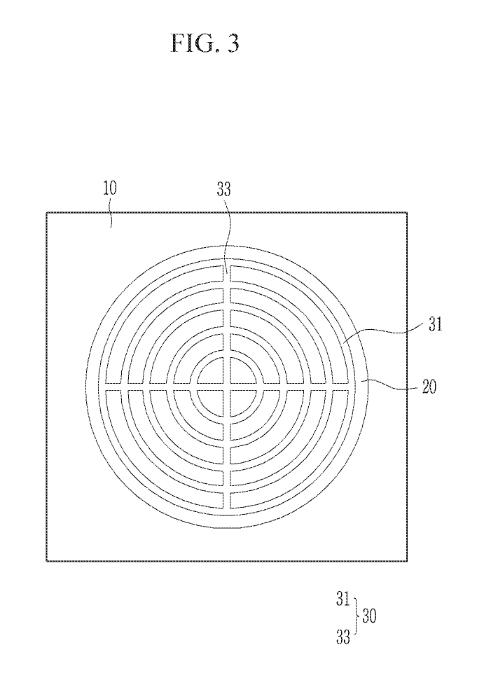

FIG. 1 illustrates a cross-sectional view of a microphone in some forms of the present disclosure, FIG. 2 illustrates a top plan view of a microphone in some forms of the present disclosure, and FIG. 3 illustrates a rear view of a microphone in some forms of the present disclosure.

Referring to FIG. 1 to FIG. 3, a microphone 1 in some forms of the present disclosure may be manufactured through a MEMS technology.

The microphone 1 includes a substrate 10, a vibration membrane 20, an electromagnetic inducing layer 30, a first electrode 40a, a second electrode 40b, a first fixing layer 50a, a second fixing layer 50b, a first coil 60a, and a second coil 60b.

The substrate 10 includes an acoustic hole 11.

In this case, the acoustic hole 11 allows air to flow to be able to assist free vibration of the vibration membrane 20.

The substrate 10 may be made of a silicon wafer.

The vibration membrane 20 is disposed at an upper portion of the substrate 10.

The vibration membrane 20 is bonded to the substrate with a first support layer 70a formed along an upper edge of the substrate 10 therebetween.

The vibration membrane 20 may be made of an insulation material, for example, a silicon nitride (SiNx) or polysilicon.

The vibration membrane 20 vertically vibrates by a sound inputted from the outside.

The electromagnetic inducing layer 30 is formed in a predetermined pattern on a lower surface of the vibration membrane 20 corresponding to the acoustic hole 11.

In this case, the predetermined pattern is provided with a plurality of circular patterns 31 in which a plurality of circular bands having different diameters are disposed at predetermined intervals, and straight line patterns 33 that interconnect the plurality of circular bands and cross a center of the circular pattern 31.

The plurality of the circular patterns 31 may be formed to have the same center.

The set pattern in some forms of the present disclosure which is provided with the circular patterns and the straight line patterns for connecting the circular patterns is exemplarily described, but the present disclosure is not limited thereto, and shapes of the patterns may be variously modified as necessary.

The electromagnetic inducing layer 30 may be made of an electromagnetic inducing material.

The first electrode 40a is disposed at an upper surface of the vibration membrane 20.

The first electrode 40a may be made of a conductive material.

The first fixing layer 50a and the second fixing layer 50b are integrally formed, and they are spaced apart from the vibration membrane 20.

A first electrode hole 53a and a second electrode hole 53b are respectively formed in one side and the other side of each of the first fixing layer 50a and the second fixing layer 50b.

Herein, the first electrode hole 53a exposes a first electrode pad 41a formed at a front end of the first electrode 40a such that the first electrode pad 41a may be electrically connected to an external signal processing circuit (not shown).

In this case, the first electrode hole 53a is formed to include a second support layer 70b formed along an upper edge of the vibration membrane 20 together with the first fixing layer 50a and the second fixing layer 50b.

In addition, the second electrode hole 53b exposes a second electrode pad 41b formed at a front end of the second electrode 40b such that the second electrode 41b may be electrically connected to the external signal processing circuit.

The second fixing layer 50b is provided with a coil groove 57 at one side thereof adjacent to the first electrode hole 53a.

The coil groove 57 exposes a first coil pad 61a formed at a front end of the first coil 60a such that the first coil pad 61a may be electrically connected to the external signal processing circuit.

A plurality of air passages 51 are formed at the first fixing layer 50a and the second fixing layer 50b corresponding to a plurality of through-holes 43 formed in the second electrode 40b that will be described later.

The second electrode 40b is formed at a lower surface of the first fixing layer 50a.

The second electrode 40b is provided with the plurality of through-holes 43.

The second electrode 40b may be made of a conductive material.

The first coil 60a is interposed between the first fixing layer 50a and the second fixing layer 50b.

The first coil 60a is formed to have a spiral shape extending outwardly from a center thereof.

The second coil 60b is bonded to an upper surface of the second fixing layer 50b. A second pad 61b is formed at a front end of the second coil 60b.

Like the first coil 60a, the second coil 60b is formed to have a spiral shape extending outwardly from a center thereof.

The respective centers of the first coil 60a and the second coil 60b are connected to each other, and the first coil 60a and the second coil 60b may be made of a conductive material.

Each of the first coil 60a and the second coil 60b in some forms of the present disclosure is formed to have the spiral shape extending outwardly from the center thereof, but the present disclosure is not limited thereto, and their shapes maybe variously modified as necessary.

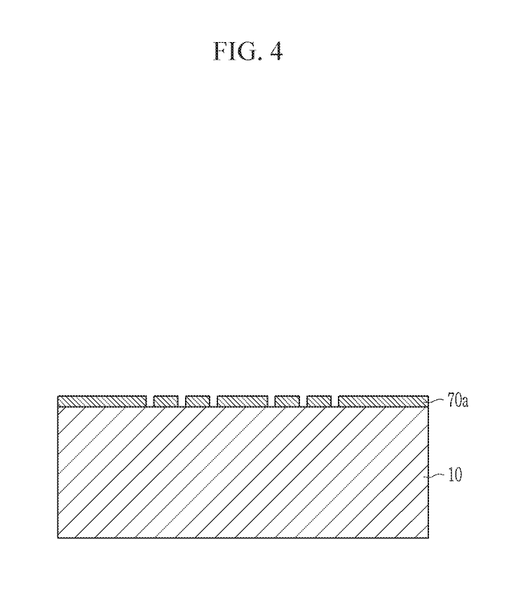

Hereinafter, a manufacturing method of the microphone in some forms of the present disclosure will be described with reference to FIG. 4 to FIG. 16.

FIG. 4 to FIG. 16 illustrate sequential processing diagrams of a manufacturing method for manufacturing the microphone in some forms of the present disclosure.

First, Referring to FIG. 4, the substrate 10 is prepared.

In this case, the substrate 10 may be made of a silicon wafer.

Next, the first support layer 70a is formed on the substrate 10, and then is patterned in a predetermined pattern.

In this case, the first support layer 70a may be made of a silicon oxide (SiOx).

The set pattern may be provided with the plurality of circular patterns 31 in which the plurality of circular bands having different diameters are disposed at predetermined intervals and the straight line patterns 33 that interconnect the plurality of circular bands and cross the center of the circular pattern 31.

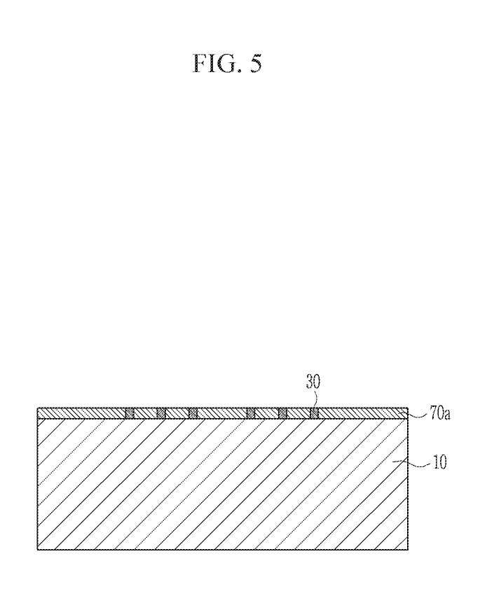

Referring to FIG. 5, the electromagnetic inducing layer 30 made of an electromagnetic inducing material is formed according to the set pattern.

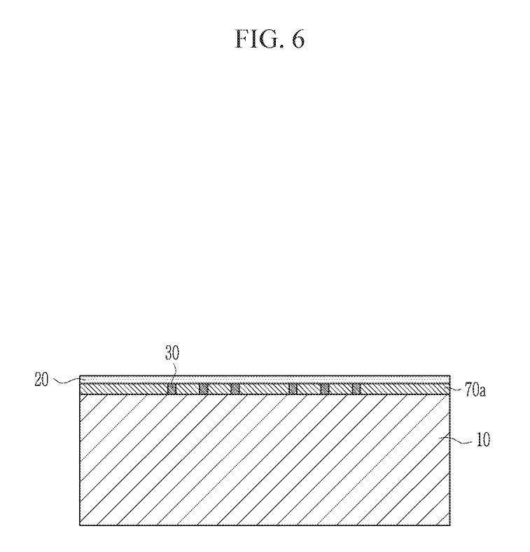

Referring to FIG. 6, the vibration membrane 20 is formed on the first support layer 70a and the electromagnetic inducing layer 30.

In this case, the vibration membrane 20 is formed to vertically vibrate by a sound inputted from the outside and by a flow of air.

The vibration membrane 20 may be made of an insulation material, for example, a silicon nitride (SiNx) or polysilicon.

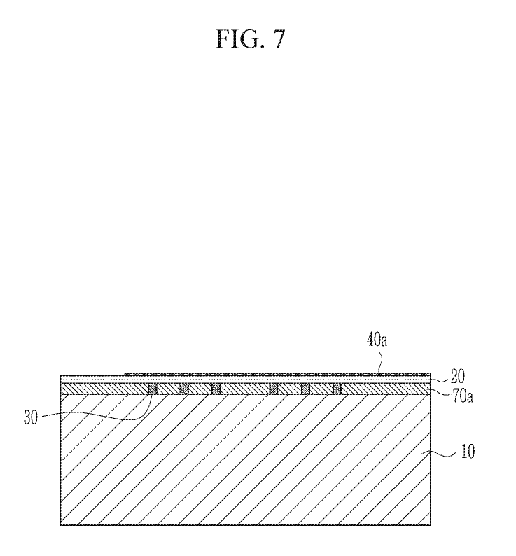

Referring to FIG. 7, the first electrode 40a is formed on the vibration membrane 20.

In this case, the first electrode 40a may be made of a conductive material.

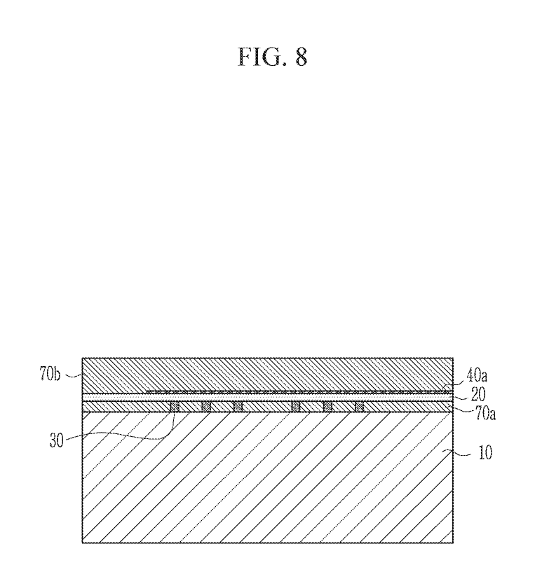

Referring to FIG. 8, the second support layer 70b is formed on the vibration membrane 20.

In this case, the second support layer 70b may be made of a silicon oxide (SiOx).

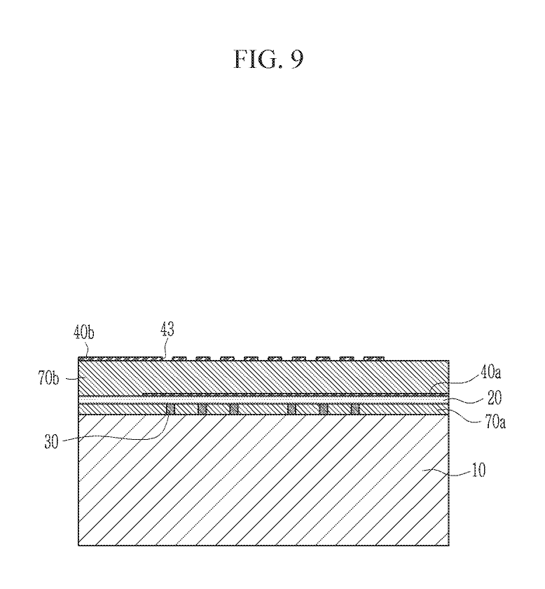

Referring to FIG. 9, the second electrode 40b is formed on the second support layer 70b.

In this case, the plurality of through-holes 43 are formed in the second electrode 40b.

The plurality of through-hole 43 may be formed to correspond to the acoustic hole 11 of the substrate 10.

The second electrode 40b may be made of a conductive material.

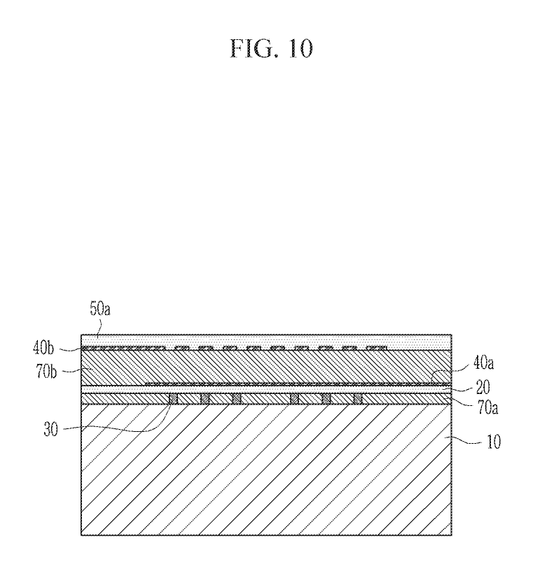

Referring to FIG. 10, the first fixing layer 50a is formed on the second support layer 70b and the second electrode 40b.

In this case, the first fixing layer 50a may be made of an insulation material, for example, a silicon nitride (SiNx) or polysilicon.

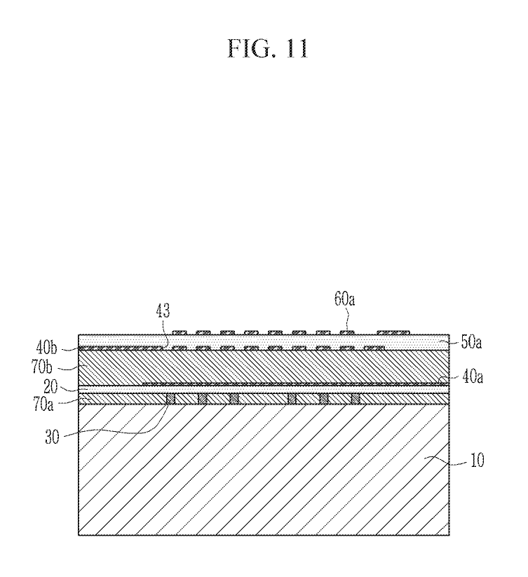

Referring to FIG. 11, the first coil 60a is formed on the first fixing layer 50a.

In this case, the first coil 60a is formed to have a spiral shape extending outwardly from a center thereof.

The first coil 60a may be made of a conductive material.

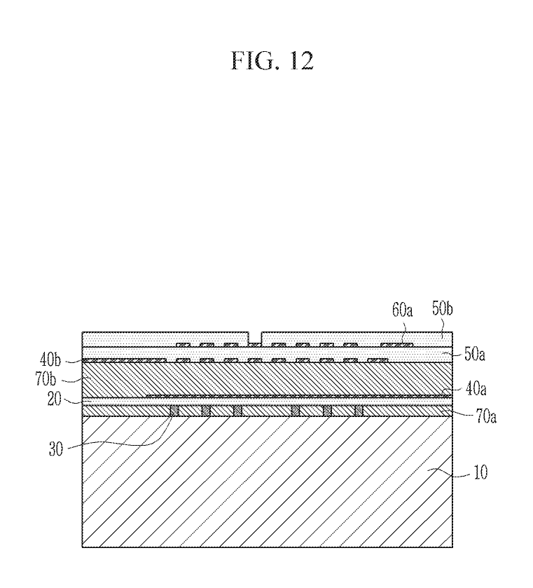

Referring to FIG. 12, the second fixing layer 50b is formed on the first fixing layer 50a to cover the first coil 60a.

In this case, the second fixing layer 50b may be formed of an insulation material, for example, a silicon nitride (SiNx) or polysilicon.

Subsequently, a central groove 55 is formed in the second fixing layer 50b corresponding to a center of the first coil 60a.

In this case, the central groove 55 exposes the first coil 60a to be able to be electrically connected.

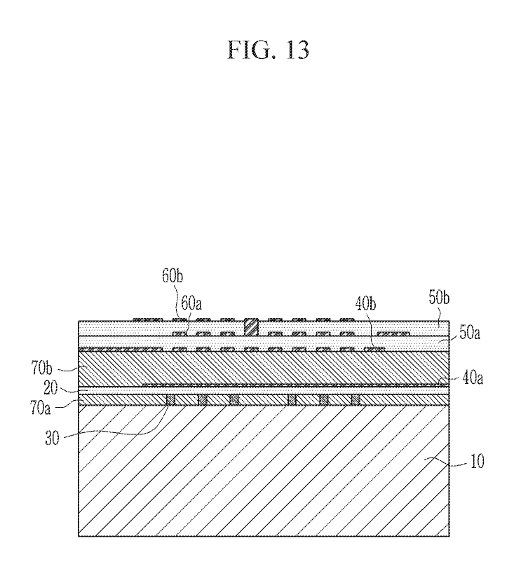

Referring to FIG. 13, the second coil 60b is formed on the second fixing layer 50b.

In this case, the center hole 55 is filled with an electromagnetic inducing material so that respective centers of the first coil 60a and the second coil 60b may be connected to each other.

The second coil 60b is connected to the center of the first coil 60a, and is formed to have a spiral shape extending outwardly from the center thereof.

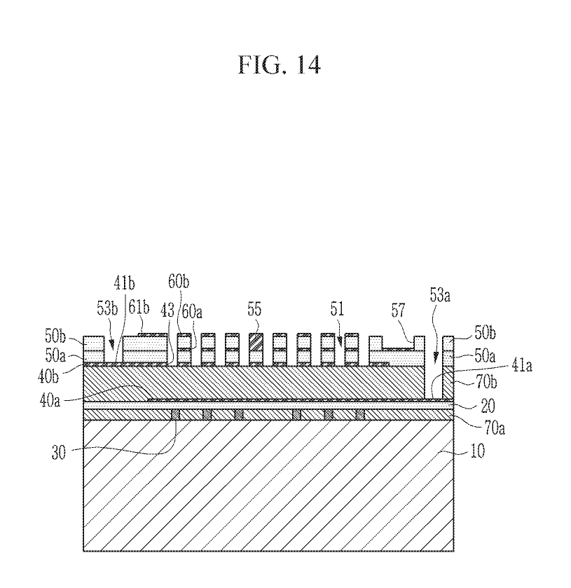

Referring to FIG. 14, the plurality of air passages 51 are formed at the first fixing layer 50a and the second fixing layer 50b.

In this case, the air passages 51 are respectively formed to correspond to the through-holes 43 of the second electrode 40b.

Since the air passages 51 allow air to flow, a first fixing layer 51a and a second fixing layer 51b may not vibrate by a sound, or may minimally vibrate.

Next, the first electrode hole 53a is formed in one side of the second fixing layer 50b so that the first electrode pad 41a formed at the front end of the first electrode 40a is exposed.

Subsequently, the second electrode hole 53b is formed in the other sides of the second fixing layer 50b and the second support layer 70b so that the second electrode pad 41b formed at the front end of the second electrode 40b is exposed.

In addition, the coil groove 57 is formed to be adjacent to the second electrode hole 53b so that the first coil pad 61a formed at the front end of the first coil 60a is exposed.

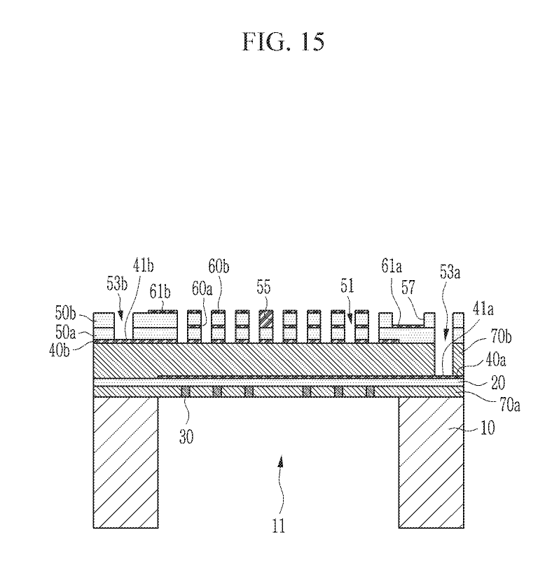

Referring to FIG. 15, the acoustic hole 11 is formed to pass through a central portion of the substrate 10.

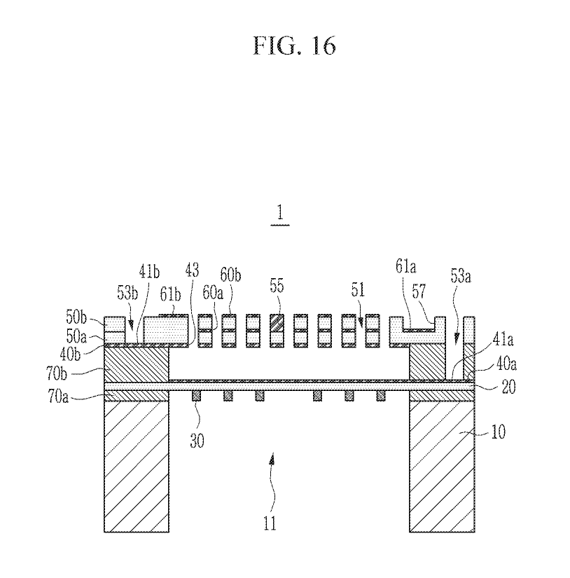

Referring to FIG. 16, the first support layer 70a corresponding to the acoustic hole 11 is etched.

Finally, the second support layer 70b corresponding to the acoustic hole 11 is etched.

Accordingly, the microphone 1 and the manufacturing method thereof in some forms of the present disclosure may improve the sensitivity by combining the electrical signal due to the capacitance change generated at the capacitance portion including the first electrode 40a and the second electrode 40b and the electrical signal due to the induced current generated at the electromagnetic inducing portion including the electromagnetic inducing layer 30, the first coil 60a, and the second coil 60b.

That is, when a sound is inputted to the microphone 1 from the outside and the vibration membrane 20 vibrates, it is possible to improve the sensitivity of the microphone by combining the capacitance value changed between the first electrode 40a and the second electrode 40b and the electromagnetic value between the first coil 60a and the second coil 60b induced by the electromagnetic inducing layer 30.

In addition, when a sound is inputted to the microphone 1 from the outside and the vibration membrane 20 vibrates, the vibration membrane 20 vertically moves while being horizontally maintained by the electromagnetic inducing layer 30 formed on the lower surface thereof, thus the distance between the fixing layers 50a and 50b may be uniformly maintained, thereby increasing the effective sensing area of the sound and improving the sensitivity of the microphone.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A microphone comprising:
a substrate having an acoustic hole;
a vibration membrane formed on the substrate;
an electromagnetic inducing layer formed on a lower surface of the vibration membrane corresponding to the acoustic hole, wherein the electromagnetic inducing layer has a predetermined pattern;
a first electrode formed on an upper surface of the vibration membrane;
a first fixing layer disposed apart from the vibration membrane;
a second fixing layer disposed apart from the vibration membrane;
a second electrode formed at a lower surface of the first fixing layer, wherein the second electrode comprises a plurality of through-holes;
a first coil interposed between the first fixing layer and the second fixing layer, wherein the first coil is formed as a spiral shape extending outwardly from a center of the first coil; and
a second coil bonded to an upper surface of the second fixing layer, wherein the second coil is formed as a spiral shape extending outwardly from a center of the second coil.

2. The microphone of claim 1, wherein the predetermined pattern of the electromagnetic inducing layer comprises:
a circular pattern, wherein a plurality of circular bands with different diameters are disposed in the circular pattern; and
a straight line pattern, wherein the straight line pattern connects the circular pattern and passes through a center of the circular pattern.

3. The microphone of claim 1, wherein the first and second fixing layers comprise:
a first electrode hole, wherein a first electrode pad formed at one side of the first electrode is exposed in the first electrode hole; and
a second electrode hole, wherein a second electrode pad formed at the other side of the second electrode is exposed in the second electrode hole.

4. The microphone of claim 3; wherein the first electrode hole comprises:
a second support layer formed along an upper edge of the vibration membrane together with the first and second fixing layers.

5. The microphone of claim 1, wherein the first and second fixing layers comprise:
a plurality of air passages disposed at a position corresponding to the plurality of through-holes formed in the second electrode.

6. The microphone of claim 1, wherein the second fixing layer comprises:
a coil groove, wherein a first coil pad formed at one end of the first coil is exposed.

7. The microphone of claim 1, wherein:
the center of the first coil is connected to the center of the second coil.

8. The microphone of claim 1, wherein:
the vibration membrane is bonded to the substrate by a first support layer, wherein the first support layer is formed along an upper edge of the substrate.

9. A manufacturing method of a microphone comprising:
forming a vibration membrane disposed on a substrate, wherein the vibration membrane includes an electromagnetic inducing lawyer formed on a lower surface of the vibration membrane and a first electrode formed on an upper surface of the vibration membrane; and
forming a fixing layer disposed apart from the vibration membrane, wherein the fixing layer includes a second electrode formed at a lower surface of the fixing layer, a first coil formed at a center of the fixing layer, and a second coil formed at an upper surface of the fixing layer.

10. The manufacturing method of the microphone in claim 9, wherein forming the vibration membrane comprises:
forming a first support layer on the substrate, and then patterning it in a predetermined pattern;
forming, with an electromagnetic inducing material, an electromagnetic inducing layer along the predetermined pattern;
forming the vibration membrane on the first support layer and the electromagnetic inducing layer; and
forming a first electrode on the vibration membrane.

11. The manufacturing method of the microphone in claim 10, wherein the predetermined pattern comprises:
a circular pattern, wherein a plurality of circular bands with different diameters are disposed at predetermined intervals; and
a straight line pattern, wherein the straight line pattern connects the circular bands and passes through a center of the circular pattern.

12. The manufacturing method of the microphone in claim 9, wherein forming the fixing layer comprises:
forming a second support layer on the vibration membrane;
forming the second electrode, wherein the second electrode comprises a plurality of through-holes formed on an upper portion of the second support layer;
forming a first fixing layer on the second electrode;
forming the first coil on the first fixing layer;
forming a second fixing layer on the first fixing layer to cover the first coil;
etching the second fixing layer, wherein a central groove is formed at a central portion of the second fixing layer; and
forming the second coil on the second fixing layer.

13. The manufacturing method of the microphone in claim 12, wherein forming the first coil and the second coil comprises:
connecting a center of the first coil to a center of the second coil; and
forming a spiral shape extending outwardly from the centers of the first coil and the second coil.

14. The manufacturing method of the microphone in claim 12, where after the second coil is formed, the method further comprises:
forming a first electrode hole, wherein a first electrode pad formed on the first electrode is exposed in one side of the second fixing layer;
forming a second electrode hole, wherein the second electrode pad formed on the second electrode is exposed in other side of the second fixing layer and the second support layer;
forming a coil groove, wherein a first coil pad formed on the first coil in a position adjacent to the second electrode hole is exposed; and
forming a plurality of air passages in the first fixing layer and the second fixing layer in a position corresponding to the through-holes of the second electrode.

15. The manufacturing method of the microphone in claim 14, where after the air passages are formed, the method further comprises:
forming an acoustic hole in the substrate;
etching the first support layer corresponding to the acoustic hole; and
etching the second support layer corresponding to the acoustic hole.
